(19) United States
(12) Patent Application Publication
(10) Pub. No.: US 2026/0304393 A1
(43) Pub. Date: Oct. 1, 2026

(54) THERMAL MANAGEMENT TECHNIQUES FOR USER EQUIPMENT

(71) Applicant: QUALCOMM Incorporated, San Diego, CA (US)

(72) Inventors: Vasanthan RAGHAVAN, West Windsor Township, NJ (US); Junyi LI, Greentown, PA (US); Jung Ho RYU, Englewood Cliffs, NJ (US)

(21) Appl. No.: 19/094,463

(22) Filed: Mar. 28, 2025

(51) Int. Cl. H04W 72/0446; H04W 16/28; H04W 72/23

(52) U.S. Cl. CPC H04W 72/0446; H04W 16/28; H04W 72/23

(57) ABSTRACT

This disclosure provides methods, components, devices and systems for thermal management techniques for a wireless device. For example, the wireless device may transmit a message that requests updates to one or more communication parameters that are used for wireless communications, wherein the request for updates to the one or more communication parameters is based at least in part on a thermal state of the wireless device satisfying a thermal threshold. The wireless device may perform subsequent wireless communications according to the updated communication parameters that are based at least in part on the request for updates to the one or more communication parameters.

### TECHNICAL FIELD

This disclosure relates generally to wireless communication, and more specifically to systems, devices, methods, and techniques associated with thermal management techniques for user equipment.

### DESCRPITION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a wireless device is described. The method may include transmitting a message that requests updates to one or more communication parameters that are used for wireless communications, where the request for updates to the one or more communication parameters is based on a thermal state of the wireless device satisfying a thermal threshold and performing subsequent wireless communications according to the updated communication parameters that are based on the request for updates to the one or more communication parameters.

A wireless device for wireless communications is described. The wireless device may include a processing system that includes processor circuitry and memory circuitry that stores code. The processing system may be configured to cause the wireless device to transmit a message that requests updates to one or more communication parameters that are used for wireless communications, where the request for updates to the one or more communication parameters is based on a thermal state of the wireless device satisfying a thermal threshold and perform subsequent wireless communications according to the updated communication parameters that are based on the request for updates to the one or more communication parameters.

Another wireless device for wireless communications is described. The wireless device may include means for transmitting a message that requests updates to one or more communication parameters that are used for wireless communications, where the request for updates to the one or more communication parameters is based on a thermal state of the wireless device satisfying a thermal threshold and means for performing subsequent wireless communications according to the updated communication parameters that are based on the request for updates to the one or more communication parameters.

A non-transitory computer-readable medium storing code for wireless communications is described. The code may include instructions executable by one or more processors to transmit a message that requests updates to one or more communication parameters that are used for wireless communications, where the request for updates to the one or more communication parameters is based on a thermal state of the wireless device satisfying a thermal threshold and perform subsequent wireless communications according to the updated communication parameters that are based on the request for updates to the one or more communication parameters.

In some examples of the method, wireless devices, and non-transitory computer-readable medium described herein, the updated communication parameters include a scheduling parameter that increases a delay between subsequent wireless communications.

In some examples of the method, wireless devices, and non-transitory computer-readable medium described herein, the delay between subsequent wireless communications includes a multi-symbol delay or a multi-slot delay.

In some examples of the method, wireless devices, and non-transitory computer-readable medium described herein, the updated communication parameters include a maximum modulation and coding scheme (MCS) used for the subsequent wireless communications.

A method for wireless communications by a network entity is described. The method may include receiving, from a wireless device, a message that requests updates to one or more communication parameters that are used for wireless communications, where the message that requests the updates to the one or more communication parameters identifies that a thermal state of the wireless device has satisfied a thermal threshold and performing subsequent wireless communications according to the updated communication parameters that are based on the request for updates to the one or more communication parameters.

A network entity for wireless communications is described. The network entity may include a processing system that includes processor circuitry and memory circuitry that stores code. The processing system may be configured to cause the network entity to receive, from a wireless device, a message that requests updates to one or more communication parameters that are used for wireless communications, where the message that requests the updates to the one or more communication parameters identifies that a thermal state of the wireless device has satisfied a thermal threshold and perform subsequent wireless communications according to the updated communication parameters that are based on the request for updates to the one or more communication parameters.

Another network entity for wireless communications is described. The network entity may include means for receiving, from a wireless device, a message that requests updates to one or more communication parameters that are used for wireless communications, where the message that requests the updates to the one or more communication parameters identifies that a thermal state of the wireless device has satisfied a thermal threshold and means for performing subsequent wireless communications according to the updated communication parameters that are based on the request for updates to the one or more communication parameters.

A non-transitory computer-readable medium storing code for wireless communications is described. The code may include instructions executable by one or more processors to receive, from a wireless device, a message that requests updates to one or more communication parameters that are used for wireless communications, where the message that requests the updates to the one or more communication parameters identifies that a thermal state of the wireless device has satisfied a thermal threshold and perform subsequent wireless communications according to the updated communication parameters that are based on the request for updates to the one or more communication parameters.

In some examples of the method, network entities, and non-transitory computer-readable medium described herein, the updated communication parameters include a scheduling parameter that increases a delay between subsequent wireless communications.

In some examples of the method, network entities, and non-transitory computer-readable medium described herein, the delay between subsequent wireless communications includes a multi-symbol delay or a multi-slot delay.

In some examples of the method, network entities, and non-transitory computer-readable medium described herein, the updated communication parameters include a maximum modulation and coding scheme (MCS) used for the subsequent wireless communications.

### BRIEF DESCRIPTION OF THE DRAWINGS

FIG. 1 shows an example of a wireless communication system.

FIG. 2 shows an example of a signaling diagram that supports thermal management techniques for user equipment (UE).

FIG. 3 shows an example of a diagram that supports thermal management techniques for UE.

FIG. 4 shows an example of a method that supports thermal management techniques for UE.

FIG. 5 shows a block diagram of a processing system that supports thermal management techniques for UE.

FIG. 6 shows a diagram of a system including a device that supports thermal management techniques for UE.

FIG. 7 shows a block diagram of a processing system that supports thermal management techniques for UE.

FIG. 8 shows a diagram of a system including a device that supports thermal management techniques for UE.

FIGS. 9 and 10 show flowcharts illustrating methods that support thermal management techniques for UE.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems, such as those in user equipments (UEs), may use various signaling techniques leading to increased power consumption, thereby needing appropriate thermal management techniques. These techniques may be applied by the wireless networks to extend battery power of the UE as well as to mitigate heating issues at the UE. In some cases, wireless communications at higher frequency ranges (e.g., beyond 7.125 GHz) may make such power consumption and thermal management more difficult to manage. For example, wireless communications at such high frequency ranges may be associated with additional radio frequency (RF) power consumption (e.g., based on using additional antennas of the UE), which may also result in increased temperature levels at the UE. In some cases, attempts to manage the thermal properties of the UE include degradation of the UE antenna capabilities, even to the point where no communications can occur.

Aspects of the subject matter described in this disclosure relate to improved power consumption and thermal management of a wireless device. The wireless device, in this example, may include a UE or may include a reflective/reconfigurable intelligent surface (RIS). The techniques described herein generally include coordination between the wireless device and the network to manage aspects of the wireless communications to manage or otherwise mitigate the thermal impacts of the wireless communications. For example, the wireless device may identify or otherwise determine that a thermal state of the wireless device has reached or otherwise satisfied a thermal threshold. Therefore, the wireless device may transmit or otherwise output a message to the network entity that requests updates to communication parameter(s) being used for wireless communications. For example, the wireless device may request an update to the scheduling parameters (e.g., delays between uplink and/or downlink communications), reducing the highest order modulation and coding scheme (MCS) that can be used, and other parameters that may impact the thermal state of the wireless device. The network entity may update the communication parameters according to the request and perform subsequent wireless communications with the wireless device using the updated communication parameters.

Particular aspects of the subject matter described in this disclosure can be implemented to realize one or more of the following potential advantages. In some examples, by updating the communication parameters at the network, the described techniques can be used to manage or otherwise mitigate the thermal state of the wireless device without having to degrade the antenna capabilities to the point where no communication occurs. Using the updated communication parameters may enable improved (e.g., reduced) power consumption and associated thermal management of the wireless device, which may improve wireless communications (e.g., while operating in higher frequency ranges).

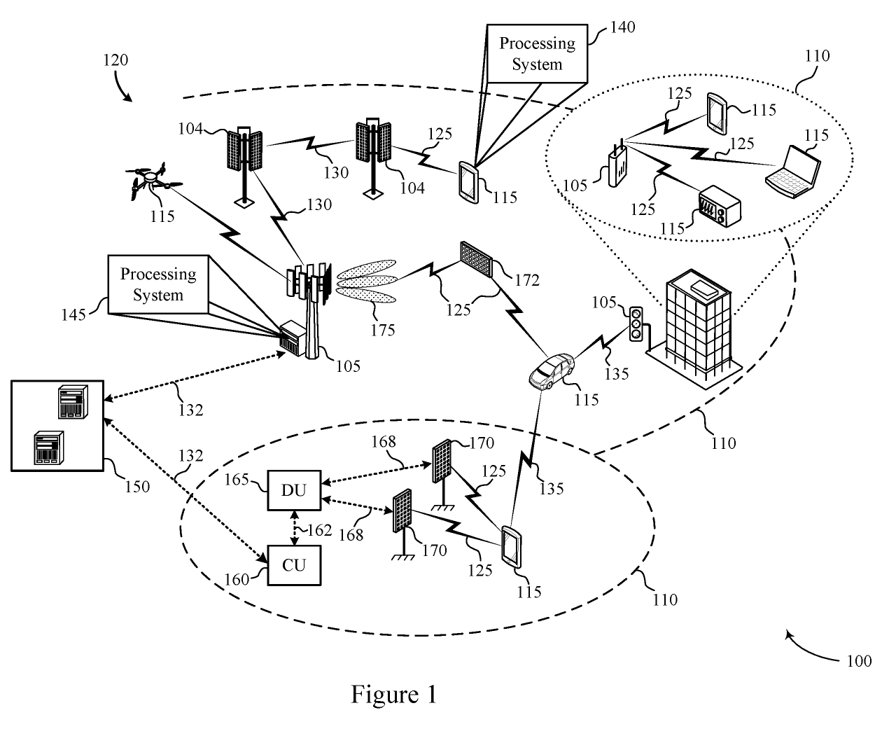

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a wireless device, a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a wireless device, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for thermal management techniques for UE 115. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support improved power consumption and thermal state management operations.

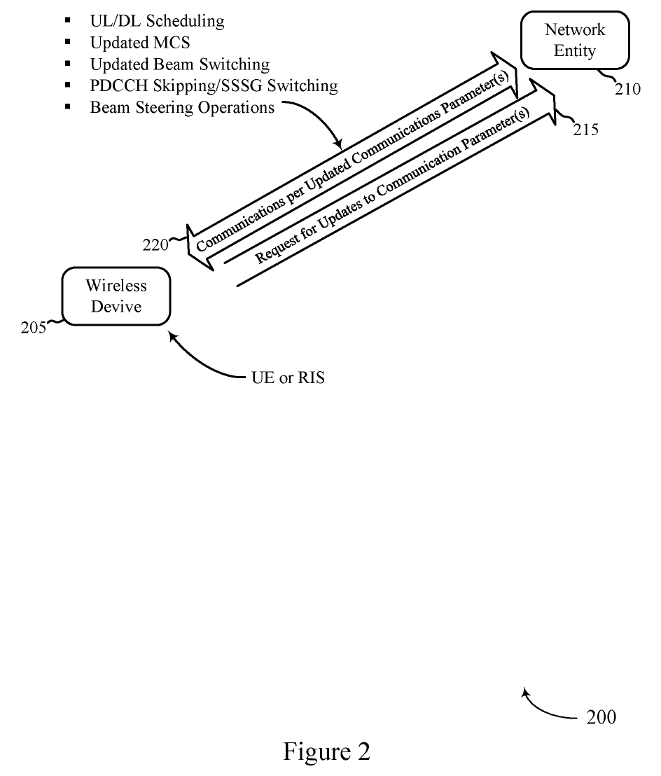

FIG. 2 shows an example of a signaling diagram 200 that supports thermal management techniques for UE. Aspects of the signaling diagram 200 may implement aspects of or be implemented by aspects of the wireless communication system 100. Aspects of the signaling diagram 200 may be implemented at or implemented by a wireless device 205 and a network entity 210, which may be examples of the corresponding devices described herein. For example, the wireless device 205 may be an example of a UE or a RIS.

The wireless devices generally rely on using as much power as possible to support high-rate wireless communications. The amount of power being consumed by the wireless device may depend on various operational states of the wireless device. For example, wireless communications involving an increased number of antennas, at higher frequency ranges (e.g., beyond 7.125 GHz), beam steering and/or switching operations, increased transmit power levels, and other communication parameters, may be associated with increased power consumption by the wireless device. Generally, increased power consumption by the wireless device may be associated with an increased thermal state of the wireless device (e.g., the wireless device gets hotter).

The thermal state of the wireless device may increase to a point where the temperature of the wireless device becomes an issue (e.g., negatively impacts the operations and/or capability of the wireless device). For example, an increased thermal state of the wireless device may decrease the reliability and efficiency of the wireless device. Accordingly, in some aspects the power consumption and thermal management may become more serious problems for the wireless device, such as when operating in a mmW frequency range (and beyond) as compared to operations at sub-7 GHz frequencies. One difference between mmW and sub-7 GHz operations is that significant RF power consumption may be seen and this may change depending on how many antennas are being used. This may differ from transmission to reception mode as different RF circuit components are excited. Another difference is that as more RF power is consumed, the wireless device may significantly heat up, thus necessitating thermal management solutions. In some wireless networks, the thermal management solutions generally consist of progressively degrading wireless device antenna capabilities to the point where no communications can happen.

Accordingly, aspects of the techniques described herein provide for different and/or alternate system level solutions to manage the increased thermal overhead in the wireless device 205 (e.g., for UEs and RIS systems. This may include the wireless device 205 communicating mitigating solutions to the network entity 210. The described techniques generally include a reduction in the highest order MCS, a reduced number of active slots, a dynamic degradation in RF capabilities, and other updates to communication parameters implemented by the network entity 210 to manage or otherwise mitigate the thermal state of the wireless device 205.

For example, at 215 the wireless device 205 may transmit or otherwise output (and the network entity 210 may receive or otherwise obtain) a message that requests updates to communication parameter(s) that are being used for wireless communications between the wireless device 205 and the network entity 210 (e.g., for uplink and/or downlink communications). In some aspects, the request for the updates to the communication parameters may be based on a thermal state of the wireless device 205 having satisfied a thermal threshold (e.g., the power consumption and/or the temperature of the wireless device 205 has exceeded a threshold). For example, when the wireless device 205 encounters an increased thermal overhead (e.g., associated with increased power consumption), the wireless device 205 may request system level modifications to the network entity 210 to mitigate this overhead.

For example, the wireless device 205 may identify or otherwise determine that the thermal state of the wireless device 205 has reached, surpassed, or otherwise satisfied a thermal threshold. The thermal threshold may be a temperature-based threshold and/or a power consumption-based threshold. The thermal threshold may be configured for the wireless device 205 (e.g., using RRC signaling, medium access control-control element (MAC-CE) signaling, downlink control information (DCI) signaling, or via other signaling means). and/or may be fixed or otherwise known by the wireless device 205. The thermal threshold may relate to an operational mode of the wireless device 205 (e.g., based on how often the wireless device 205 is performing uplink and/or downlink communications within a timer period, based on the modulation and coding scheme (MCS) being used for such wireless communications, and/or based on various other communication parameters being used for the wireless communications). The thermal threshold may relate to a temperature of the wireless device 205 and/or a battery level of the wireless device 205.

Accordingly, the wireless device 205 may request updates to various communication parameter(s) being to be used for subsequent wireless communications based on the thermal state having reached, exceeded, or otherwise satisfied the thermal threshold. The wireless device 205 may request updates to one, some, or all of the communication parameters.

In some cases, the updates to the communication parameters may include a scheduling parameter that increases a delay (e.g., a multi-symbol delay and/or a multi-slot delay) between subsequent wireless communications. The wireless device 205 may request the scheduling of downlink and/or uplink data only once in a few symbols and/or slots. Such long delays may require more coordination between the UE and the network entity. As one example, the wireless device 205 may request data only during one slot in every four slots or during one slot of every eight slots. The wireless device 205 may enter a sleep or idle state or operating mode during the inactive slots, thus allowing the wireless device 205 to mitigate thermal overhead.

In some cases, the updates to the communication parameters may include a maximum MCS used for the subsequent wireless communications. The wireless device 205 may request a reduction in the maximum MCS that is used for data transmissions. For example, as the power consumption may be directly proportional to the constellation size (e.g., due to the associated decoding overhead) and the coding scheme used, this may reduce the power consumption and, therefore, the thermal overhead of the wireless device 205.

In some cases, the updates to the communication parameters may include a reduced value for a maximum number of beam switches within a slot and/or for an increased number of symbols or slots in which a quasi-colocation (QCL) metric may be applied. The wireless device 205 may dynamically update a reduced value for a number of receive or transmit beam switches for downlink communications (e.g., a maxNumberRxTxBeamSwitchDL information element (IE)) or an increased value for a time duration for a QCL metric (e.g., a timeDurationForQCL IE), which indirectly leads to reduced power consumption and/or thermal overhead. Generally, such metrics are fixed and signaled to the network entity 210 via capability signaling at the beginning of the communication session (e.g., during a boot up operation). However, the techniques described herein provide for such metrics to be dynamically updated by the wireless device 205 to manage or otherwise mitigate the power consumption and/or thermal state of the wireless device 205.

In some cases, the updates to the communication parameters may include the activation of physical downlink control channel (PDCCH) skipping configuration and/or activation of a search space set group (SSSG) switching configuration for the wireless device 205. PDCCH skipping is a power saving mode where the wireless device 205 reduces the number and/or periodicity with which the wireless device 205 is to monitor the PDCCH. Similarly, the SSSG switching configuration allows the wireless device 205 to switch to a SSSG (which generally defines the search space resources that the wireless device 205 is to monitor for PDCCH) with an increased periodicity. In some wireless networks, only the network entity 210 can activate PDCCH skipping and/or SSSG switching for the wireless device 205. However, the techniques described herein provide for the wireless device 205 to request PDCCH skipping and/or SSSG switching to reduce power consumption and the associated thermal overhead.

In some cases, the wireless device 205 may be an example of a RIS. The RIS are generally useful for providing alternate paths in a dense multipath environment where blockage can dominate and prevent good connectivity between the network entity 210 and UE. In this context, the RIS may perform high-speed electronic beam steering based on dynamically switching the setting of the RIS elements. This may result in increased thermal overheads at the RIS. Accordingly, in this example the updates to the communication parameters may include a reduction in beam steering operations or parameters associated with the wireless device 205. In the RIS context, the RIS may request updates to limit the high-speed electronic beam steering operations to more manageable limits, thus resulting in less thermal overheads. Additionally, or alternatively, the requested updates to the communication parameters may include more strategies, such as limiting the scan angles, limiting the codebook sizes, limiting the beamforming operations, or other parameters to control the thermal overhead.

The network entity 210 may receive the request from the wireless device 205 and update the communication parameters accordingly. For example, the network entity 210 may update the scheduling parameter, limit the maximum MCS, reduce the beam switches, etc., for subsequent wireless communications with the wireless device 205. Accordingly, at 220 the wireless device 205 and the network entity 210 may perform subsequent wireless communications according to the updated communication parameters (e.g., based on the request).

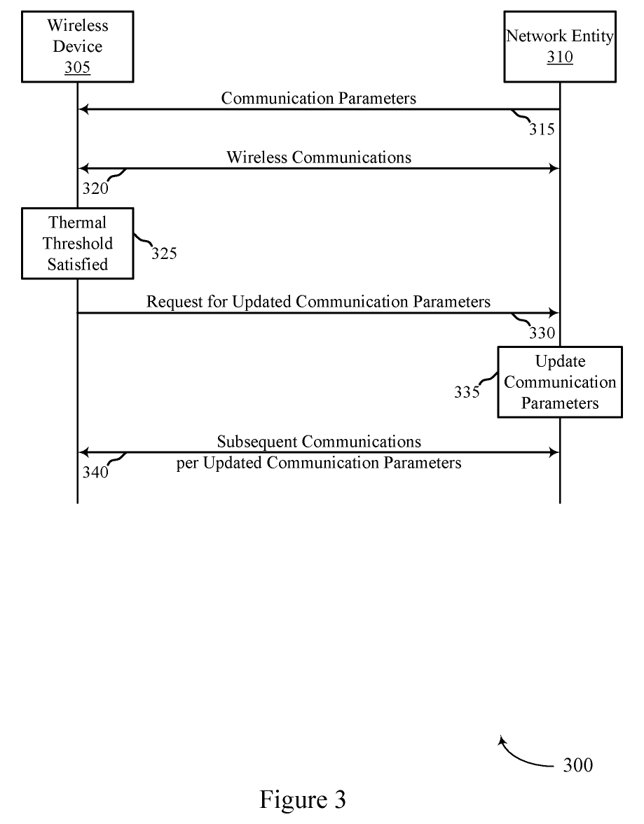

FIG. 3 shows an example of a diagram 300 that supports thermal management techniques for UE. Aspects of the diagram 300 may be implemented by or may implement aspects of the wireless communication system 100 and/or the signaling diagram 200. Aspects of the diagram 300 may be implemented at or implemented by a wireless device 305 and a network entity 310, which may be examples of the corresponding devices described herein. For example, the wireless device 305 may be an example of a UE or a RIS.

At 315, the network entity 310 may transmit or otherwise output (and the wireless device 305 may receive or otherwise obtain) a signal that identifies various communication parameters to be used for wireless communications between the wireless device 305 and the network entity 310 (e.g., downlink communications or uplink communications). The signal may be a RRC signal, a MAC-CE signal, and/or a DCI signal. In some examples, the signal may include a DCI signal that identifies resources as well as the communication parameters to be used for the wireless communications. Generally, the network entity 310 may identify or otherwise select the communication parameters based on various factors, such as the amount of data being communicated, the channel conditions, or other features or considerations.

At 320, the wireless device 305 and the network entity 310 may perform the wireless communications according to the communication parameters. The wireless communications may include uplink communications and/or downlink communications. For example, the wireless communications may be performed using the MCS, using a scheduling parameter, and the like.

At 325, the wireless device 305 may identify or otherwise determine that a thermal threshold has been satisfied. The thermal threshold may be based on a power consumption state or mode of the wireless device 305 and/or based on a thermal status of the wireless device 305. For example, the thermal threshold may be satisfied when the power consumption level has reached or satisfied a power consumption threshold and/or when the thermal state of the wireless device 305 has reached or satisfied a thermal state threshold.

At 330, the wireless device 305 may transmit or otherwise output a message that requests updates to communication parameter(s) that are used for wireless communications between the wireless device 305 and the network entity 310. The request may be transmitted based on the thermal state of the wireless device 305 satisfying the threshold. The requested updates to the communication parameter(s) may include, but are not limited to, a scheduling parameter that increases the delay between subsequent wireless communications (e.g., a multi-symbol delay and/or a multi-slot delay), a reduction in the maximum MCS, a reduction in beam switches within a slot, and the like.

At 335, the network entity 310 may update the communication parameters according to the request. That is, the network entity 310 may select, identify, or otherwise determine updated communications parameters according to the request received from the wireless device 305. In some aspects, the network entity 310 may update the communications parameters to manage or otherwise mitigate the power consumption level and/or the thermal state of the wireless device 305.

At 340, the wireless device 305 and the network entity 310 may perform subsequent wireless communications according to the updated communication parameters. For example, the network entity 310 may update the communication parameters in one or more grants scheduling the subsequent wireless communications according to the request to manage the thermal state of the wireless device 305.

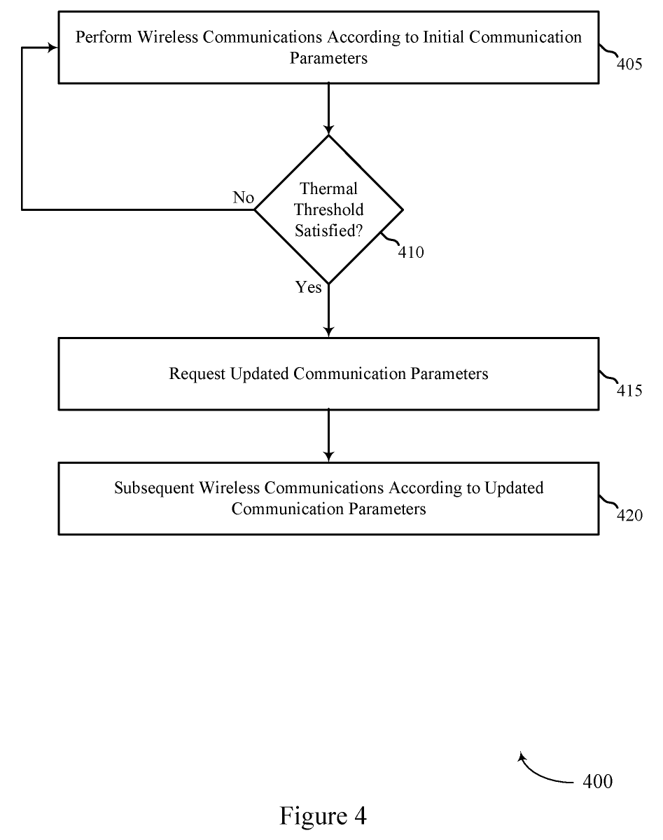

FIG. 4 shows an example of a method 400 that supports thermal management techniques for UE. Aspects of the method 400 may be implemented by or may implement aspects of the wireless communication system 100 and/or the signaling diagram 200. Aspects of the method 400 may be implemented at or implemented by a wireless device and a network entity, which may be examples of the corresponding devices described herein. For example, the wireless device may be an example of a UE or a RIS.

At 405, the wireless device may be performing wireless communications with a network entity. The wireless communications may include uplink communication and/or downlink communications. The wireless communications may be performed according to an initial set of communication parameters. The initial set of communication parameters may be based on various factors or conditions associated with the wireless device, with the network entity, or with both devices. However, the initial communication parameters may not consider the thermal state of the wireless device.

At 410, the wireless device may identify or otherwise determine that a thermal threshold has been satisfied. The thermal threshold may be based on a power consumption state or mode of the wireless device and/or based on a thermal status of the wireless device. For example, the thermal threshold may be satisfied when the power consumption level has reached or satisfied a power consumption threshold and/or when the thermal state of the wireless device has reached or satisfied a thermal state threshold.

If the thermal state of the wireless device has not reached the thermal threshold, the wireless device may continue to perform wireless communications with the network entity according to the initial communication parameters.

If the thermal state of the wireless device has reached or otherwise satisfied the thermal threshold, at 415 the wireless device may request updates to the initial communication parameters. For example, the wireless device may transmit or otherwise output a message that requests updates to communication parameter(s) that are used for wireless communications between the wireless device and the network entity. The request may be transmitted based on the thermal state of the wireless device satisfying the threshold. The requested updates to the communication parameter(s) may include, but are not limited to, a scheduling parameter that increases the delay between subsequent wireless communications (e.g., a multi-symbol delay and/or a multi-slot delay), a reduction in the maximum MCS, a reduction in beam switches within a slot, and the like. The network entity may update the communication parameters according to the request. For example, the network entity may select, identify, or otherwise determine updated communications parameters according to the request received from the wireless device. In some aspects, the network entity may update the communications parameters to manage or otherwise mitigate the power consumption level and/or the thermal state of the wireless device.

At 420, the wireless device and the network entity may perform subsequent wireless communications according to the updated communication parameters. For example, the network entity may update the communication parameters in one or more grants scheduling the subsequent wireless communications according to the request to manage the thermal state of the wireless device 305.

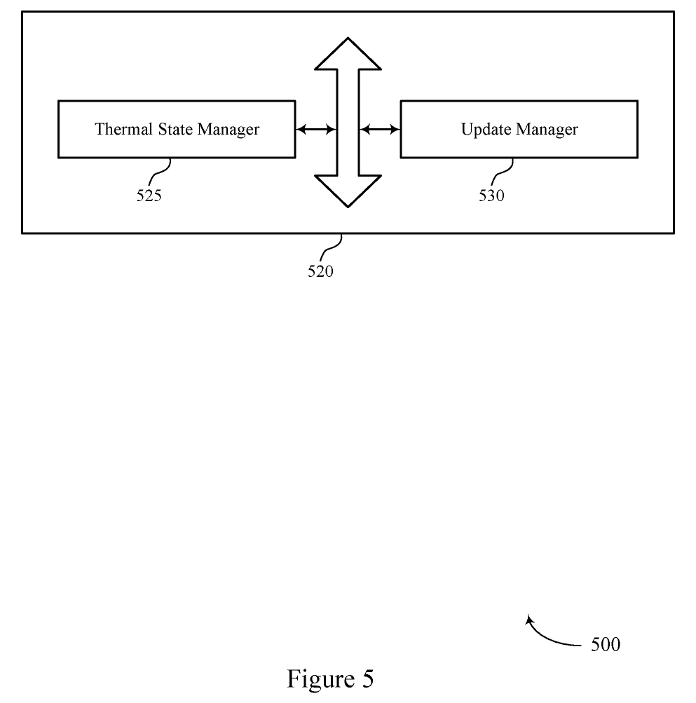

FIG. 5 shows an example of a processing system 520 that supports thermal management techniques for UE. A processing system 520 may be an example of a processing system 140 (such as of a UE 115) and may include a thermal state manager 525 an update manager 530, or any combination thereof. A processing system 520, or various component thereof, may be an example of means for performing (such as a means for causing a UE 115 to perform) various techniques described herein.

The thermal state manager 525 may be configured to cause the UE 115 to transmit a message that requests updates to one or more communication parameters that are used for wireless communications, where the request for updates to the one or more communication parameters is based on a thermal state of the wireless device satisfying a thermal threshold. The update manager 530 may be configured to cause the UE 115 to perform subsequent wireless communications according to the updated communication parameters that are based on the request for updates to the one or more communication parameters. In some examples, the updated communication parameters include a scheduling parameter that increases a delay between subsequent wireless communications. In some examples, the delay between subsequent wireless communications includes a multi-symbol delay or a multi-slot delay.

In some examples, the updated communication parameters include a maximum MCS used for the subsequent wireless communications. In some examples, the updated communication parameters include a reduced value for a maximum number of beam switches within a slot. In some examples, the updated communication parameters include an increased value for a number of symbols in which a QCL metric can be applied. In some examples, the updated communication parameters include an activation of a PDCCH skipping configuration for the wireless device. In some examples, the updated communication parameters include an activation of a SSSG switching configuration for the wireless device. In some examples, the updated communication parameters include a reduction in beam steering operations or parameters associated with the wireless device. In some examples, the wireless device includes a RIS device. In some examples, the wireless device includes a UE or a RIS.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved power consumption and thermal state management operations at a wireless device. Upon detection that the thermal state of the wireless device has satisfied a thermal threshold, the wireless device may request updates to various communication parameters by the network to mitigate the thermal state of the wireless device.

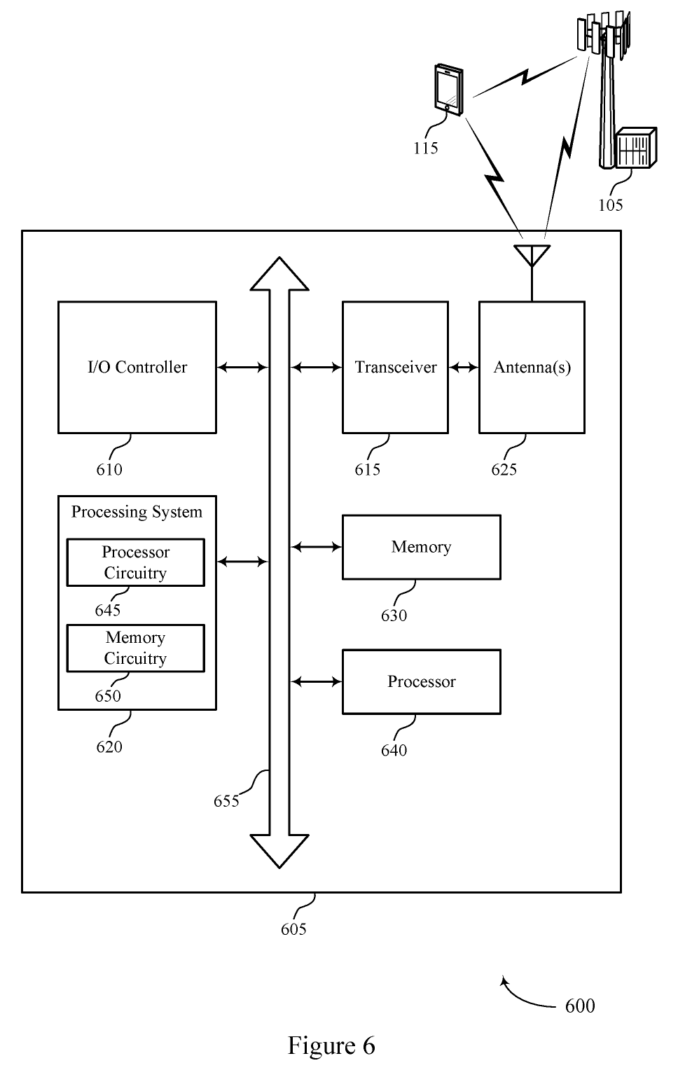

FIG. 6 shows an example of a system 600 including a device 605 that supports thermal management techniques for UE. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support thermal management techniques for UE. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved power consumption and thermal state management operations at a wireless device. Upon detection that the thermal state of the wireless device has satisfied a thermal threshold, the wireless device may request updates to various communication parameters by the network to mitigate the thermal state of the wireless device.

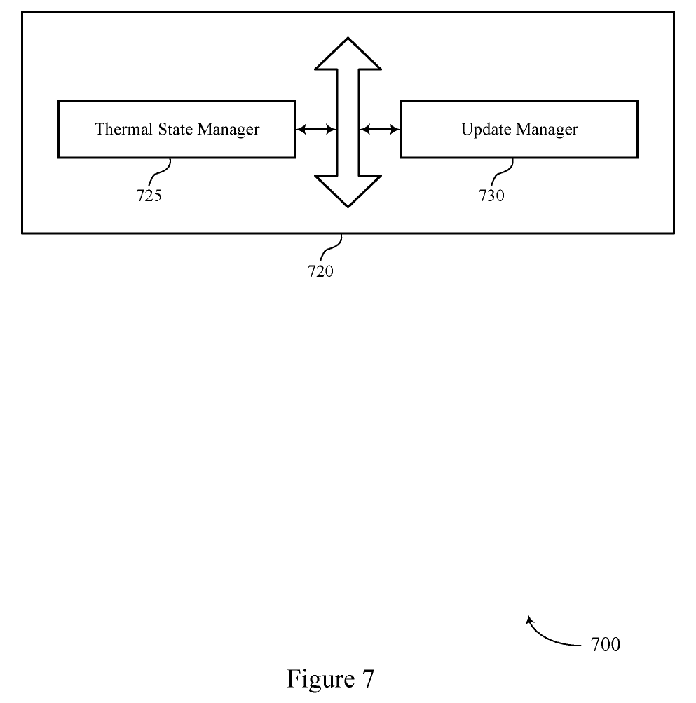

FIG. 7 shows an example of a processing system 720 that supports thermal management techniques for UE. A processing system 720 may be an example of a processing system 145 (such as network entity 105) and may include a thermal state manager 725 an update manager 730, or any combination thereof. A processing system 720, or various component thereof, may be an example of means for performing (such as a means for causing a network entity 105 to perform) various techniques described herein.

The thermal state manager 725 may be configured to cause the network entity 105 to receive, from a wireless device, a message that requests updates to one or more communication parameters that are used for wireless communications, where the message that requests the updates to the one or more communication parameters identifies that a thermal state of the wireless device has satisfied a thermal threshold. The update manager 730 may be configured to cause the network entity 105 to perform subsequent wireless communications according to the updated communication parameters that are based on the request for updates to the one or more communication parameters.

In some examples, the updated communication parameters include a scheduling parameter that increases a delay between subsequent wireless communications. In some examples, the delay between subsequent wireless communications includes a multi-symbol delay or a multi-slot delay. In some examples, the updated communication parameters include a maximum MCS used for the subsequent wireless communications. In some examples, the updated communication parameters include a reduced value for a maximum number of beam switches within a slot. In some examples, the updated communication parameters include an increased value for a number of symbols in which a QCL metric can be applied. In some examples, the updated communication parameters include an activation of a PDCCH skipping configuration for the wireless device. In some examples, the updated communication parameters include an activation of a SSSG switching configuration for the wireless device. In some examples, the updated communication parameters include a reduction in beam steering operations or parameters associated with the wireless device. In some examples, the wireless device includes a RIS device. In some examples, the wireless device includes a UE or a RIS.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for improved power consumption and thermal state management operations at a wireless device. Upon detection that the thermal state of the wireless device has satisfied a thermal threshold, the wireless device may request updates to various communication parameters by the network to mitigate the thermal state of the wireless device.

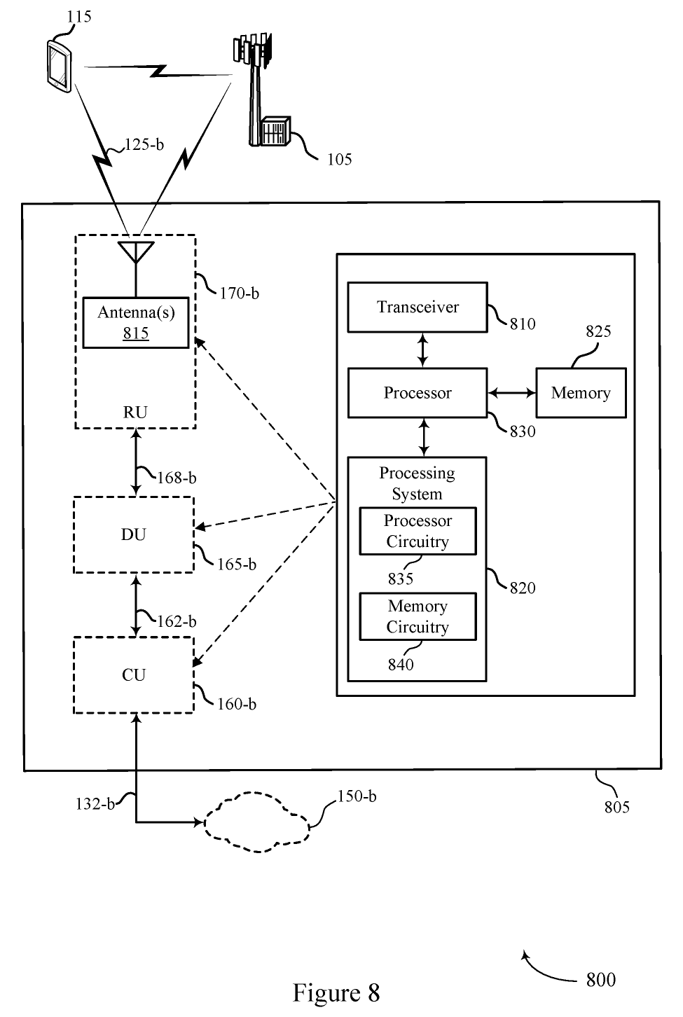

FIG. 8 shows an example of a system 800 including a device 805 that supports thermal management techniques for UE. The device 805 may communicate (such as via one or more wired interfaces or one or more wireless interfaces) with other devices, wireless devices, or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 700. For example, the processing system 820 may include processor circuitry 835 and memory circuitry 840 that stores code, and the processing system 820 may be configured to cause the device 805 to perform operations that support thermal management techniques for UE. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for improved power consumption and thermal state management operations at a wireless device. Upon detection that the thermal state of the wireless device has satisfied a thermal threshold, the wireless device may request updates to various communication parameters by the network to mitigate the thermal state of the wireless device.

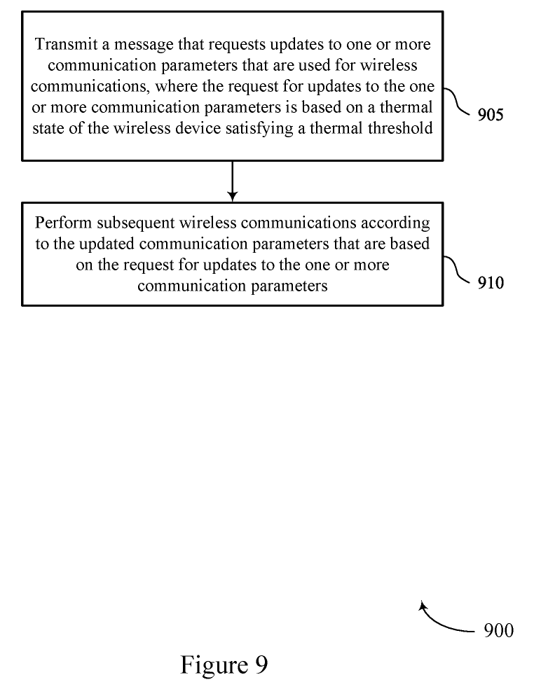

FIG. 9 shows an example of a method 900 that supports thermal management techniques for UE. Operations of the method 900 may be performed by a wireless device (e.g., a UE 115 and/or a network entity 105) or its components (such as using a processing system configured to cause the wireless device to perform one or more of the operations) as described herein.

At 905, the method may include transmitting a message that requests updates to one or more communication parameters that are used for wireless communications, where the request for updates to the one or more communication parameters is based on a thermal state of the wireless device satisfying a thermal threshold. In some examples, aspects of the operations of 905 may be performed by a thermal state manager 525.

At 910, the method may include performing subsequent wireless communications according to the updated communication parameters that are based on the request for updates to the one or more communication parameters. In some examples, aspects of the operations of 910 may be performed by an update manager 530.

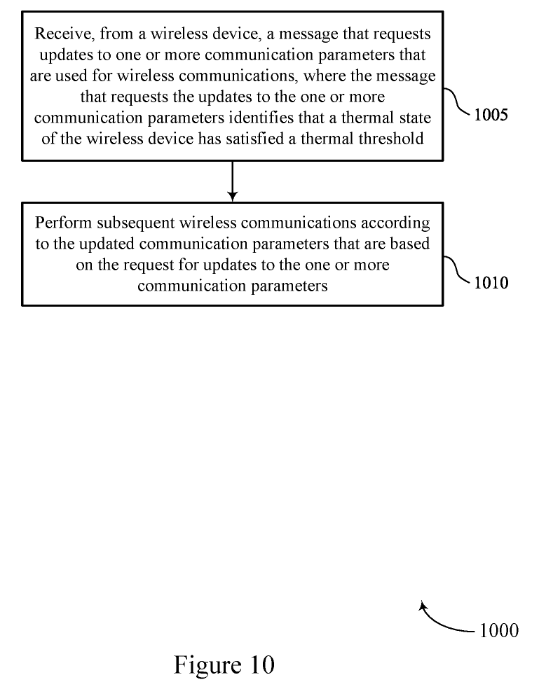

FIG. 10 shows an example of a method 1000 that supports thermal management techniques for UE. Operations of the method 1000 may be performed by a wireless device (e.g., a UE 115 and/or a network entity 105) or its components (such as using a processing system configured to cause the wireless device to perform one or more operations) as described herein.

At 1005, the method may include receiving, from a wireless device, a message that requests updates to one or more communication parameters that are used for wireless communications, where the message that requests the updates to the one or more communication parameters identifies that a thermal state of the wireless device has satisfied a thermal threshold. In some examples, aspects of the operations of 1005 may be performed by a thermal state manager 725.

At 1010, the method may include performing subsequent wireless communications according to the updated communication parameters that are based on the request for updates to the one or more communication parameters. In some examples, aspects of the operations of 1010 may be performed by an update manager 730.

Implementation examples are described in the following numbered clauses:

Aspect 1: A method for wireless communications at a wireless device, comprising: transmitting a message that requests updates to one or more communication parameters that are used for wireless communications, wherein the request for updates to the one or more communication parameters is based at least in part on a thermal state of the wireless device satisfying a thermal threshold; and performing subsequent wireless communications according to the updated communication parameters that are based at least in part on the request for updates to the one or more communication parameters.

Aspect 2: The method of aspect 1, wherein the updated communication parameters comprise a scheduling parameter that increases a delay between subsequent wireless communications.

Aspect 3: The method of aspect 2, wherein the delay between subsequent wireless communications comprises a multi-symbol delay or a multi-slot delay.

Aspect 4: The method of any of aspects 1 through 3, wherein the updated communication parameters comprise a maximum MCS used for the subsequent wireless communications.

Aspect 5: The method of any of aspects 1 through 4, wherein the updated communication parameters comprise a reduced value for a maximum number of beam switches within a slot.

Aspect 6: The method of any of aspects 1 through 5, wherein the updated communication parameters comprise an increased value for a number of symbols in which a QCL metric can be applied.

Aspect 7: The method of any of aspects 1 through 6, wherein the updated communication parameters comprise an activation of a PDCCH skipping configuration for the wireless device.

Aspect 8: The method of any of aspects 1 through 7, wherein the updated communication parameters comprise an activation of a SSSG switching configuration for the wireless device.

Aspect 9: The method of any of aspects 1 through 8, wherein the updated communication parameters comprise a reduction in beam steering operations or parameters associated with the wireless device.

Aspect 10: The method of aspect 9, wherein the wireless device comprises a RIS device.

Aspect 11: The method of any of aspects 1 through 10, wherein the wireless device comprises a UE or a RIS.

Aspect 12: A method for wireless communications at a network entity, comprising: receiving, from a wireless device, a message that requests updates to one or more communication parameters that are used for wireless communications, wherein the message that requests the updates to the one or more communication parameters identifies that a thermal state of the wireless device has satisfied a thermal threshold; and performing subsequent wireless communications according to the updated communication parameters that are based at least in part on the request for updates to the one or more communication parameters.

Aspect 13: The method of aspect 12, wherein the updated communication parameters comprise a scheduling parameter that increases a delay between subsequent wireless communications.

Aspect 14: The method of aspect 13, wherein the delay between subsequent wireless communications comprises a multi-symbol delay or a multi-slot delay.

Aspect 15: The method of any of aspects 12 through 14, wherein the updated communication parameters comprise a maximum MCS used for the subsequent wireless communications.

Aspect 16: The method of any of aspects 12 through 15, wherein the updated communication parameters comprise a reduced value for a maximum number of beam switches within a slot.

Aspect 17: The method of any of aspects 12 through 16, wherein the updated communication parameters comprise an increased value for a number of symbols in which a QCL metric can be applied.

Aspect 18: The method of any of aspects 12 through 17, wherein the updated communication parameters comprise an activation of a PDCCH skipping configuration for the wireless device.

Aspect 19: The method of any of aspects 12 through 18, wherein the updated communication parameters comprise an activation of a SSSG switching configuration for the wireless device.

Aspect 20: The method of any of aspects 12 through 19, wherein the updated communication parameters comprise a reduction in beam steering operations or parameters associated with the wireless device.

Aspect 21: The method of aspect 20, wherein the wireless device comprises a RIS device.

Aspect 22: The method of any of aspects 12 through 21, wherein the wireless device comprises a UE or a RIS.

Aspect 23: A wireless device for wireless communications, comprising a processing system that includes processor circuitry and memory circuitry that stores code, the processing system configured to cause the wireless device to perform a method of any of aspects 1 through 11.

Aspect 24: A wireless device for wireless communications, comprising at least one means for performing a method of any of aspects 1 through 11.

Aspect 25: A non-transitory computer-readable medium storing code for wireless communications, the code comprising instructions executable by one or more processors to perform a method of any of aspects 1 through 11.

Aspect 26: A network entity for wireless communications, comprising a processing system that includes processor circuitry and memory circuitry that stores code, the processing system configured to cause the network entity to perform a method of any of aspects 12 through 22.

Aspect 27: A network entity for wireless communications, comprising at least one means for performing a method of any of aspects 12 through 22.

Aspect 28: A non-transitory computer-readable medium storing code for wireless communications, the code comprising instructions executable by one or more processors to perform a method of any of aspects 12 through 22.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
a processing system that includes processor circuitry and memory circuitry that stores code, the processing system configured to cause the wireless device to:
transmit a message that requests updates to one or more communication parameters that are used for wireless communications, wherein the request for updates to the one or more communication parameters is based at least in part on a thermal state of the wireless device satisfying a thermal threshold; and
perform subsequent wireless communications according to the updated communication parameters that are based at least in part on the request for updates to the one or more communication parameters.

2. The wireless device of claim 1, wherein the updated communication parameters comprise a scheduling parameter that increases a delay between subsequent wireless communications.

3. The wireless device of claim 2, wherein the delay between subsequent wireless communications comprises a multi-symbol delay or a multi-slot delay.

4. The wireless device of claim 1, wherein the updated communication parameters comprise a reduced value for a maximum number of beam switches within a slot.

5. The wireless device of claim 1, wherein the updated communication parameters comprise an increased value for a number of symbols in which a quasi-colocation (QCL) metric can be applied.

6. The wireless device of claim 1, wherein the updated communication parameters comprise an activation of a physical downlink control channel (PDCCH) skipping configuration for the wireless device.

7. The wireless device of claim 1, wherein the updated communication parameters comprise an activation of a search space set group (SSSG) switching configuration for the wireless device.

8. The wireless device of claim 1, wherein the updated communication parameters comprise a reduction in beam steering operations or parameters associated with the wireless device.

9. The wireless device of claim 8, wherein the wireless device comprises a reconfigurable intelligent surface (RIS) device.

10. The wireless device of claim 1, wherein the wireless device comprises a user equipment (UE) or a reconfigurable intelligent surface (RIS).

11. A network entity, comprising:
a processing system that includes processor circuitry and memory circuitry that stores code, the processing system configured to cause the network entity to:
receive, from a wireless device, a message that requests updates to one or more communication parameters that are used for wireless communications, wherein the message that requests the updates to the one or more communication parameters identifies that a thermal state of the wireless device has satisfied a thermal threshold; and
perform subsequent wireless communications according to the updated communication parameters that are based at least in part on the request for updates to the one or more communication parameters.

12. The network entity of claim 11, wherein the updated communication parameters comprise a scheduling parameter that increases a delay between subsequent wireless communications.

13. The network entity of claim 12, wherein the delay between subsequent wireless communications comprises a multi-symbol delay or a multi-slot delay.

14. The network entity of claim 11, wherein the updated communication parameters comprise a maximum modulation and coding scheme (MCS) used for the subsequent wireless communications.

15. The network entity of claim 11, wherein the updated communication parameters comprise a reduced value for a maximum number of beam switches within a slot.

16. The network entity of claim 11, wherein the updated communication parameters comprise an increased value for a number of symbols in which a quasi-colocation (QCL) metric can be applied.

17. The network entity of claim 11, wherein the updated communication parameters comprise an activation of a physical downlink control channel (PDCCH) skipping configuration for the wireless device.

18. The network entity of claim 11, wherein the updated communication parameters comprise an activation of a search space set group (SSSG) switching configuration for the wireless device.

19. The network entity of claim 11, wherein the updated communication parameters comprise a reduction in beam steering operations or parameters associated with the wireless device.

20. A method for wireless communications at a wireless device, comprising:
transmitting a message that requests updates to one or more communication parameters that are used for wireless communications, wherein the request for updates to the one or more communication parameters is based at least in part on a thermal state of the wireless device satisfying a thermal threshold; and
performing subsequent wireless communications according to the updated communication parameters that are based at least in part on the request for updates to the one or more communication parameters.
